(19) United States
(12) Patent Application Publication
(10) Pub. No.: US 2011/0244232 A1
(43) Pub. Date: Oct. 6, 2011

(54) Processes for Forming Adhesive Blend Compositions

(76) Inventors: Gregory K. Hall, Humble, TX (US); Jim N. Coffey, League City, TX (US)

(21) Appl. No.: 12/753,416

(22) Filed: Apr. 2, 2010

(51) Int. Cl. B05D 5/10; B32B 27/04

(52) U.S. Cl. 428/355 EN; 427/207.1

(57) ABSTRACT

Continuous or continual in-line processes for forming adhesive polymer blend compositions are described, as well as the application of those blends to a variety of substrates. In one or more embodiments, a first polymer component is provided in a first vessel, and a second polymer component is provided in a second vessel. The first polymer component comprises one or more styrenic block copolymers and one or more hydrocarbon tackifier resins, and the second polymer component comprises a polyolefin. The first and second polymer components are extracted from their respective holding vessels, mixed, and applied to a substrate. In some embodiments, the first and second polymer components may further comprise various additives. Adhesive blend compositions formed from the inventive processes are also described.

### BACKGROUND

Adhesive polymer compositions are well known in the art. Polyolefin-based adhesive (“POA”) compositions, for example, are known in the art and are useful for a variety of end use applications, such as the manufacture of diapers and other personal hygiene products. Other applications for polyolefin-based adhesives may include corrugate, case and carton sealing, packaging, woodworking, bookbinding, labeling, and general adhesion where it may be advantageous to use a hot melt adhesive. Polyolefin-based adhesives can often be difficult to handle and store; however, because the additives required to obtain the desired performance characteristics of the adhesive (such as tackifiers, waxes, adhesion promoters, etc.) are compounded with the polyolefin and pelletized before the adhesive is shipped to end users. The presence of these additives in the adhesive pellets creates storage stability issues due to the tackiness of the pellets, such as pellet agglomeration and poor flow characteristics. The pellets may be dusted before shipping and storage, which helps to reduce storage stability problems but leads to additional processing concerns such as environmental and housekeeping issues resulting from dust in the air, as well as added cost.

Hot melt adhesive (“HMA”) formulations are also well known in the art. Such adhesives typically comprise styrenic block copolymers, but may be formed from other polymers as well. Hot melt adhesives are easily tailored to a variety of end uses, because of the wide range of additives that can be compounded with the adhesives to form a finished adhesive product well-suited to each particular application. Additives typically compounded with hot melt adhesives include tackifiers, plasticizers, antioxidants, process oils, and waxes, among others. Such hot melt adhesive formulations have drawbacks as well, however, such as expense, additional compounding costs, potential sourcing and supply issues if certain raw material components are scarce, the need to formulate in stabilizing agents, excessive tackiness or stickiness leading to potential agglomeration of product form (i.e., pellets, pillows, bricks, etc.), and limitation of formulations adjustability by the end user per desired performance and or preferred substrate, improved adhesive handling and transfer from a simplified essentially non-tacky product form (pellet, pillow, brick, etc.). Lastly, the shear number of compounded raw materials becomes increasingly disadvantageous as there may be limitations of number of available feed hoppers on blending equipment, more raw materials to inventory, more expense, more potential for variability in final blend performance. The present invention gives the ability to expand the total number of raw materials into the final adhesive in the product from generally 3-5 range, to for example 8-10 additives (with the combined on-line formulation). Additionally, most HMAs are best suited for one type of application; however the present inventive concept would allow for one adhesive to be adjusted for several applications. For example, a diaper and feminine care pad manufacturer who may typically purchase as many as 4-8 adhesives, may purchase a POA and a nonwoven construction type HMA from an alternate supplier, and then use these two adhesives to tailor blend for non-elastic areas of diaper/pads, elastic areas of diaper/pads (typically needing an “elastic attachment type adhesive”), ear tab attachment, a garment adhesive for feminine care pads, and as a case & carton sealing adhesive for the finished bagged diapers prior to shipment.

The present invention addresses these problems by providing separately a POA and an HMA, which are mixed in an in-line continuous or continual process and applied to a substrate. The POA may comprise additives, but is generally free from additive such as tackifiers, thus greatly reducing the storage and handling problems previously experienced when using such adhesives. The HMA, on the other hand, may comprise a wide variety of additives, including one or more tackifiers, tailored to the desired end use. For example, by providing the two adhesive components separately and mixing the POA with a comparatively small amount of the HMA formulation (i.e., from about 5 to about 45 percent by weight based on the weight of the overall composition) just prior to applying the blend to a substrate, an adhesive blend composition is formed that comprises all of the desired additives and performance characteristics required for a particular application while avoiding the drawbacks experienced when using a POA or an HMA alone.

### SUMMARY

The present invention is directed to continuous or continual in-line processes for forming adhesive polymer blend compositions, as well as the application of those blends to a variety of substrates. In one or more embodiments, a first polymer component is provided in a first vessel, and a second polymer component is provided in a second vessel. The first polymer component comprises one or more styrenic block copolymers and one or more hydrocarbon tackifier resins, and the second polymer component comprises a polyolefin. The first and second polymer components are extracted from their respective holding vessels, mixed, and applied to a substrate. In some embodiments, the first and second polymer components may further comprise various additives. Adhesive blend compositions formed from the inventive processes are also contemplated herein.

### BRIEF DESCRIPTION OF THE FIGURES

FIGS. 1 through 4 illustrate various in-line continuous or continual process configurations useful in the practice of the present invention.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

As used herein, the term “homopolymer” means polymers resulting from the polymerization of a single monomer, i.e., a polymer consisting essentially of a single type of repeating unit. As used herein, the term “copolymer(s)” refers to polymers formed by the polymerization of at least two different monomers and may further refer to interpolymers, terpolymers, etc. The term “polymer” as used herein includes homopolymers and copolymers.

The adhesive blend compositions of the present invention comprise a first adhesive polymer component and a second adhesive polymer component. The first polymer component comprises a styrenic block copolymer and one or more tackifiers. The first polymer component may also comprise one or more additives. The second polymer component comprises a polyolefin, and may also comprise one or more additives but preferably is substantially free of tackifier. Each of the polymer components and the additives that may be used in conjunction with the polymer components are described in more detail in the following paragraphs.

The present invention also includes in-line continuous or continual processes for forming an adhesive blend composition. By “continual” is meant a system that operates repeatedly with short interruptions (or is intended to operate). Typically, the interruptions in a continual process will be less than five seconds such as less than three seconds, such as less than one second. By “continuous” is meant a system that operates (or is intended to operate) without interruption or cessation. It is to be understood that the mixing of each component may be continual or continuous on an “as-needed basis” based on how the adhesive composition blend is applied to the substrate. It is also to be understood that the continuous or continual process is distinguishable from a batch process wherein a large amount of the adhesive components is mixed together in a holding vessel prior to being applied to the substrate.

In one or more embodiments, such processes comprise providing a first component in a first vessel, providing a second component in a second vessel, and providing a substrate upon which the adhesive blend composition is to be applied. The processes further comprise extracting the first and second components of the blend from their respective vessels and mixing the first and second components to form an adhesive blend composition before the composition is applied to the substrate. In some embodiments, the first and second components may each comprise one or more additives, and in the same or other embodiments one or more additives may also be added to the blend of the first and second components during the mixing step.

In another embodiment, the intermittent pulsing of the at least two components being mixed may be adjusted such that predominantly one component is deposited in distinctly preferred areas of the substrate and a second component is deposited in distinctly different preferred areas of the substrate, then one application head may be used to apply the two adhesive components along the same machine direction lane of the substrate(s). For example, a construction hot melt adhesive comprising a styrenic block copolymer is intermittently mixed/applied with a polyolefin adhesive to form at least two distinct intermittent blends wherein a first intermittent blend predominately comprises (greater than 55% of one component) at least one construction hot melt adhesive such as an adhesive comprising a styrenic block copolymer wherein the first intermittent blend is then deposited in the non-elastic areas of a diaper (e.g. between the topsheet and backsheet), and a second intermittent blend predominantly comprising at least one polyolefin adhesive is deposited in the elastic areas between the topsheet and backsheet and along the elastic member (e.g. spandex or polyisoprene rubber strands), thus taking advantage of previously stated advantages of two components as well as reducing the number of adhesive applicator heads employed. This may be referred to as a “registered—intermittent” application of said bi-alternating blend composition, where registered term refers to placement or depositing the preferred bi-alternating composition to the intermittently varying product/substrate (e.g. as in a diaper where leg elastics are intermittently applied and stretch bonded between the backsheet and topsheet). “Elastic area” or “elastic member zone” refers to any portion of elastically active material such as a strand, ribbon, film, or nonwoven.

“Elastic” is used herein to generally refer to a material that is capable of recovering its shape after deformation when the deforming force is removed. Specifically, as used herein, elastic is meant to be that property of any material which, upon application of a deforming force, permits the material to be elongated to a length which is at least about 50 percent greater than its relaxed non-deformed length, and that will cause the material to recover at least 40 percent of its elongation upon release of the stretching force. For example, an elastic material could be a 10 centimeter sample of a material which is elongatable to at least 15 centimeters and which, upon being elongated to 15 centimeters and released, will recover to a length of less than 13 centimeters. Many elastic materials may be stretched by much more than 50 percent of their relaxed length, and many of these will recover to substantially their original relaxed length upon release of the deforming force. Elastic materials (or elastic members) may include such things as strands, ribbons, films, or nonwovens.

As used herein, the term “nonelastic” refers to any material which does not fall within the definition of “elastic,” above.

### First Polymer Component

In one or more embodiments of the present invention, the first adhesive polymer component comprises one or more styrenic block copolymers. The phrase “block copolymer” is intended to include any manner of block copolymer having two or more polymer chains attached at their ends, including but not limited to diblock, triblock, and tetrablock copolymers. “Block copolymer” is further meant to include copolymers having any structure known to those of skill in the art, including but not limited to linear, radial or multi-arm star, multi-branched block copolymers, and random block copolymers. “Linear block copolymers” comprise two or more polymer chains in sequence. “Radial block copolymers” (or “star block copolymers”) comprise more than two linear block copolymers attached at a common branch point. “Styrenic block copolymers” comprise a block copolymer having at least one block that is substantially styrene. While the block copolymers may be linear or radial, combinations of linear and radial block copolymers are particularly useful. The block copolymers may or may not be hydrogenated.

A linear diblock copolymer traditionally has the formula (A-B) wherein A is substantially a vinyl aromatic block and B is substantially a polydiene block. The polydiene in the B block may be a conjugated diene block or the B block may be a combination of conjugated dienes such as polyisoprene and polybutadiene either in block or random order.

A linear diblock (A-B) may also include a random block copolymer wherein the B block may include styrene randomly inserted into the B block in addition to the one or more dienes. Examples of such random block copolymers having styrene included in the B block include Solprene™ 1205 (a linear random-block styrene-butadiene copolymer having a 25% bound styrene content, 17.5% present as a polystyrene block, and a specific gravity of 0.93) available from Dynasol Elastomeros S. A. de C.V. of Mexico.

The vinyl aromatic block may be derived from styrene, alpha-methylstyrene, p-methylstyrene, o-methylstyrene, p-tert-butylstyrene, 2,4-dimethylstyrene, diphenylethylenes including stilbene, vinyl naphthalene, vinyltoluene (a mixture of meta- and para-isomers of methylstyrene), vinylxylene and combinations thereof. Of these vinyl aromatic monomers, styrene is preferred, although the vinyl aromatic block may comprise styrene and less than 5 wt % of the other vinyl aromatic monomers previously mentioned.

A linear styrene-diene-styrene triblock copolymer would traditionally have the formula (A-B-A) wherein A is substantially a vinyl aromatic block and B is substantially a polydiene block. The polydiene in the B block may be a conjugated diene block or the B block may be a combination of conjugated dienes such as polyisoprene and polybutadiene either in block or random order. In another embodiment, the B block may also include styrene randomly inserted into the B block in addition to the one or more dienes to form a random block copolymer.

Suitable block copolymers include linear block copolymers of styrene and one or more conjugated dienes such as SI (styrene-isoprene), SIS (styrene-isoprene-styrene), SB (styrene-butadiene), SBS (styrene-butadiene-styrene), SIB (styrene-isoprene-butadiene), or combination thereof.

Block copolymers comprising tetrablock or pentablock copolymers selected from A-B-A-B tetrablock copolymers or A-B-A-B-A pentablock copolymers and the like are also suitable such as SISI (styrene-isoprene-styrene-isoprene), SISB, SBSB, SBSI, SIBS, ISISI, ISISB, BSISB, ISBSI, BSBSB, and BSBSI block copolymers.

In one or more embodiments, the linear block copolymer includes a linear polymer of the formula S-I-S or S-B-S wherein S is substantially a polystyrene block, I is substantially a polyisoprene block, and B is substantially a polybutadiene block.

The styrene content of the SBS block copolymer is typically from about 10 to about 45 wt %, or from about 15 to about 35 wt %, or from about 20 to 30 wt %. The SIS block copolymers may be prepared by well known anionic solution polymerization techniques using lithium-type initiators such as disclosed in U.S. Pat. Nos. 3,251,905 and 3,239,478, which are hereby incorporated by reference in their entireties. The SIS and the SBS copolymer may be a pure triblock (one having less than 0.1 wt % of diblock polymer, preferably 0% diblock polymer), or may contain from about 0.1 to about 85 wt %, or from about 0.1 to about 75 wt %, or from about 1 to about 65 wt %, or from about 5 to about 50 wt %, or from 5 to 25 wt %, or from 10 to 20 wt % diblock copolymer having the structure S-I or SB, respectively. The SI or SB diblock may be present as a residue from the manufacture of the triblock copolymer or may be separately blended with the triblock as a further technique for achieving target polystyrene content or modifying the cohesive properties of the composition. In one or more embodiments, the number average molecular weight of the diblock SI copolymers may range from about 100,000 to about 250,000.

The SBS or SIS linear block copolymers employed herein may have a number average molecular weight (Mn) (determined by GPC) in the range of from about 50,000 to 500,000, or from about 100,000 to about 180,000, or from about 110,000 to about 160,000, or from about 110,000 to about 140,000.

Linear SBS and SIS block copolymers of the type described herein are available commercially and are prepared in accordance with methods known in the art. Examples of SBS and SIS copolymers useful in the practice of this invention include those available under the trade names Vector (from Dexco Polymers LLP), Kraton (from Kraton Polymers LLC), Europrene (from Polimeri), and Finaprene (from Total PetroChemicals). Particularly useful triblock copolymers include, but are not limited to, Vector™ 4111A, 4113A, 4114A, 4211A, 4215A, 4411A, 2518A, 2518P, 4461, 6241, 7400, and 8508A; Kraton D 1102, D 4141, D 4158, Europrene SOL T 166, and Finaprene 411. In one or more embodiments, the SIS block copolymers used in this invention may have a melt flow rate in the range of from about 5 to 40 g/10 min, as measured by ASTM D 1238 using condition G (200° C., 5 kg weight).

In one or more embodiments, the block copolymer component may be a radial block copolymer. A radial block copolymer would traditionally have the notation (A-B)nX wherein A is substantially a vinyl aromatic block such as styrene, B is substantially a polydiene block, X is the residue of a multifunctional coupling agent used in the production of the radial block copolymer, and n is an integer of from about 2 to about 10, from 3 to 8, from 3 to 7, from 4 to 6, or 4. In the same or other embodiments, the radial block copolymer component may have a linear block copolymer content of from about 0 to about 85 wt % such as a diblock copolymer. Linear block content may be determined by GPC, and may be manipulated via the reactor settings employed to produce the block copolymer component. Linear block content may also be adjusted after production by blending an additional quantity of linear block material into the block copolymer component. Linear block content in the radial block copolymer may be from 5 to 90 wt %, 15 to about 90 wt %, or from about 20 to about 85 wt %, or from about 25 to about 80 wt %.

The production of radial block copolymers often results in an amount of block copolymer that is linear in structure, along with the radial structure. Also, a linear block copolymer may be added to the radial block copolymer to modify the properties of the block copolymer. These block copolymers may be referred to in terms of their linear block content such as a diblock content, wherein the linear block content (expressed as a percentage) refers to the amount of copolymer that is linear in structure. The remaining portion of the block copolymer not included in the linear block percentage is therefore radial in structure. Accordingly, the radial block copolymer (A-B)n will typically comprise a linear component (A-B) wherein A is substantially a vinyl aromatic block and B is substantially a polydiene block. A typical notation for such a radial/linear combination is (A-B)n/A-B. The vinyl aromatic content (e.g. styrene) of the (A-B)n block copolymer or the (A-B)n/A-B block copolymer composition is typically from about 10 to about 45 wt %, or from about 15 to about 35 wt %, or from about 17 to 22 wt %.

Suitable block copolymer compositions comprising radial and linear block copolymers such as (SI)n/(SI) may have a diblock content of from about 15 to about 90 wt %, or from about 20 to about 85 wt %, or from about 25 to about 80 wt %. Other suitable block copolymers include (SB)n/(SB) which may have a diblock content of from about 5 to about 90 wt %, or from about 5 to about 50 wt %, or from about 5 to about 25 wt %, or from about 5 to about 15 wt %.

These radial block copolymers are multi-armed, and may have, for example, three, four, five, or more arms extending from a central point in a radial fashion, wherein one end of each arm is connected to the other arms at the center of the copolymer structure via a coupling agent or coupling group. Coupling agents are well known in the art, and any suitable multifunctional coupling agent may be used to form the radial block copolymers described herein. Suitable coupling agents may include, for example, silanes, liquid and metallic multifunctional acrylates and methacrylates, functionalized polybutadiene resins, functionalized cyanurate, allyl isocyanurate, and diesters.

In some embodiments, the radial block copolymer component is a styrenic block copolymer chosen from a styrene-isoprene (SI)n block copolymer or a styrene-butadiene (SB)n block copolymer. In other embodiments, the radial block copolymer may comprise a mixture of a radial and linear block copolymer such as (SI)n/(SI) or (SB)n/(SB).

The radial (A-B)n or (A-B)n/A-B block copolymers employed herein may have a Mn in the range of from about 50,000 to 500,000, or from about 70,000 to about 250,000, or from about 90,000 to about 175,000, or from about 90,000 to about 135,000. Specifically, radial SI or SB copolymers useful in the practice of the invention may have a Mn of from about 180,000 to about 250,000.

The radial block copolymers or radial and linear block copolymer compositions useful for the present invention may additionally have a melt flow rate (MFR) (200° C., 5 kg) from about 5 to about 35 g/10 min, or from about 10 to about 30 g/10 min, or from about 12 to about 25 g/10 min Further, the copolymers may have a specific gravity from about 0.90 to about 0.97, or from about 0.92 to about 0.95; a Mn from about 125,000 to about 300,000, or from about 150,000 to about 275,000, or from about 175,000 to about 250,000; and/or a Shore A hardness (ASTM D 2240) from about 35 to about 55, or from about 40 to about 50. Suitable radial block copolymer compositions with linear block copolymer such as (SI)n/(SI) include, but are not limited to, those available under the trade names Vector 4230 and Vector 4186A from Dexco Polymers LLP. Suitable radial block copolymer compositions with linear block copolymer such as (SB)n/(SB) include, but are not limited to, those available under the trade names Vector 2411 and 2411P from Dexco Polymers LLP.

In other embodiments, radial styrenic triblock copolymers and other styrenic block copolymers suitable for use in the present invention include those described in U.S. Application Pub. No. 2009/0133834, which is incorporated by reference herein in its entirety.

The radial or linear A-B block copolymers may comprise a blend of two or more different A-B copolymers, which may have the same or different styrene content, and may be blended to a ratio in the range of from 10:1 to 1:10 parts by weight. The use of two different A-B block copolymers may offer improved cohesive strength and allow more precise tailoring of the polystyrene content.

In another embodiment, the B block (diene block) may be hydrogenated. For example, hydrogenating the B block (diene block) of an A-B diblock or an A-B-A triblock may produce a B block comprising at least one olefin wherein the olefin is chosen from ethylene, propylene, and butylene. Suitable block copolymers are the Kraton™ G Series polymers including SEP (styrene-ethylene-propylene), SEBS (styrene-ethylene-butylene-styrene) and SEPS (styrene-ethylene-propylene-styrene). Examples of the Kraton™ G series that are commercially available include Kraton™ G1702H (diblock) and Kraton™ A1535H (triblock).

### Second Polymer Component

In one or more embodiments of the present invention, the second adhesive polymer component comprises one or more polyolefin adhesive (“POA”) polymer compositions, which include propylene polymers. Propylene-based polymers are polymers comprised of a majority of propylene monomers on a molar basis. As used herein, “polypropylene”, “polypropylene polymer(s)”, or “propylene polymer(s)” mean (i) homopolymers, copolymers, terpolymers, higher order copolymers, or interpolymers comprised of a majority of propylene monomers on a molar basis or (ii) combinations thereof.

The second polymer component described herein comprises at least one propylene polymer. The propylene polymer can be a propylene homopolymer or a propylene copolymer having at least 50 wt % propylene derived units and one or more other olefins. For example, the propylene polymer can contain about 58 wt %, about 60 wt %, about 65 wt %, about 70 wt %, about 75 wt %, about 80 wt %, about 85 wt %, about 90 wt %, about 92 wt %, about 94 wt %, about 95 wt %, about 96 wt %, about 97 wt %, about 98 wt %, or about 99 wt % of propylene derived units with the balance being a comonomer such as ethylene or one or more C₄ to C₁₂ alpha-olefins.

One, two or more comonomers can be copolymerized with propylene. Suitable comonomers may be derived from ethylene or alpha-olefins containing 4 to 12 carbon atoms. Exemplary α-olefins may be selected from the group consisting of ethylene; 1-butene; 1-heptene; 1 -hexene; 1-methyl-1-hexene; dimethyl-1-pentene; trimethyl-1-butene; ethyl-1-pentene; 1-octene; methyl-1-pentene; dimethyl-1-hexene; trimethyl-1-pentene; ethyl-1-hexene; 1-methylethyl-1-pentene; 1-diethyl-1-butene; propyl-1-pentene; 1-decene; methyl-1-nonene; 1-nonene; dimethyl-1-octene; trimethyl-1-heptene; ethyl-1-octene; methylethyl-1-butene; diethyl-1-hexene; 1-dodecene and 1-hexadodecene. In one or more embodiments, the C₄ to C₁₂ alpha-olefins are those having 6 to 8 carbon atoms, such as for example 1-hexene.

In one or more embodiments, the propylene polymer can include about 1 wt % to about 30 wt %, about 2 wt % to about 30 wt %, about 2 wt % to about 15 wt %, about 2 wt % to about 12 wt %, about 2 wt % to about 10 wt %, about 5 wt % to about 15 wt %, about 5 wt % to about 12 wt %, or about 5 wt % to about 12 wt % of units derived from ethylene or at least one C₄ to C₁₂ alpha-olefin. In one or more embodiments, the propylene polymer contains about 85 wt % to about 95 wt % of propylene-derived units and about 5 wt % to about 15 wt % of units derived from ethylene or at least one C₄ to C₁₂ alpha-olefin. In one or more embodiments above or elsewhere herein, the propylene polymer is a copolymer comprising propylene and hexene.

The propylene polymer can have a weight average molecular weight (Mw) that is less than 250,000. In one or more embodiments, the Mw of the propylene polymer is less than 100,000, 90,000, 80,000, 75,000, 70,000, 65,000, 60,000, 55,000, 50,000, 40,000, 30,000, 20,000 or 15,000, and at least 10,000, 12,000, 15,000, 20,000, 25,000, 35,000, 45,000, 55,000, 65,000, 75,000, or 85,000. In some embodiments, the Mw of the polymer ranges from a low about 5,000, about 10,000, or about 15,000 to a high of about 60,000, about 80,000, or about 100,000. In the same or other embodiments, the Mw of the propylene polymer ranges from a low about 10,000, about 16,000, or about 22,000 to a high of about 66,000, about 78,000, or about 98,000.

The molecular weight distribution (“MWD”) of the propylene polymer is the ratio of the weight average molecular weight (Mw) of the propylene polymer to the Mn of the propylene polymer, and may be from about 1.8 to about 9.0. In one or more embodiments, the MWD is from about 2.0 to about 9.0. In further embodiments, the MWD is from about 2.0 to about 5.0. In one or more embodiments, the MWD of the propylene polymer can range from a low about 1.8, 2.4, or 3.0 to a high of about 4.0, 5.5, or 8.5. The MWD of the propylene polymer can also range from a low about 1.8, 2.6, or 3.2 to a high of about 5.3, 7.5, or 8.8.

In one or more embodiments, the propylene polymer can have a melting point (Tm) of about 40° C. to about 150° C. The melting point of the propylene polymer can range from about 60° C. to about 140° C.; about 60° C. to about 110° C.; about 80° C. to about 140° C.; about 85° C. to about 125° C.; or about 90° C. to about 120° C.; or about 95° C. to about 110° C. The melting point of the propylene polymer can further range from a low of about 40° C., 60° C., or 70° C. to high of about 100° C., 110° C., or 120° C. The melting point of the propylene polymer can also range from a low of about 85° C., 95° C., or 100° C. to high of about 105° C., 115° C., or 130° C.

In some embodiments, the propylene polymer can have a heat of fusion as determined by differential scanning calorimetry (DSC) between about 5 J/g and about 100 J/g. For example, the heat of fusion of the propylene polymer can range from about 10 J/g to about 75 J/g; about 10 J/g to about 60 J/g; or about 20 J/g to about 50 J/g; or about 20 J/g to about 40 J/g. The heat of fusion can further range from a low about 5 J/g, 10 J/g, 15 J/g or 20 J/g to a high of about 35 J/g, 45 J/g, 55 J/g, 65 J/g, 75 J/g, 85 J/g or 100 J/g.

The propylene polymer can have a percent crystallinity of about 2% to about 50%. For example, the percent crystallinity of the propylene polymer can range from about 5% to about 40%; or about 5% to about 30%; or about 5% to about 25%. The percent crystallinity can further range from a low about 5%, 10% or 15% to a high of about 20%, 30%, 40% or 50%. The percent crystallinity can further range from a low about 10%, 15% or 20% to a high of about 30%, 40% or 50%.

The propylene polymer can have a melt index (1₂) of 25 dg/min or more, 30 dg/min or more, 50 dg/min or more, 100 dg/min or more, 200 dg/min or more, 500 dg/min or more, or 2,000 dg/min or more, as measured by ASTM D 1238(B) at 2.16 kg, 190° C. In one or more embodiments, the propylene polymer can have a melt index greater than 3,000 dg/min; greater than 4,000 dg/min, greater than 5,000 dg/min.

In one or more embodiments, the propylene polymer can have a branching index (g′) of 0.95 or less measured at the Mz of the propylene polymer when the polymer has an Mw of 10,000 to 100,000. The propylene polymer can also have a branching index (g′) of 0.98 or less measured at the Mz of the propylene polymer when the propylene polymer has an Mw of 10,000 to 60,000.

In some embodiments, the polymer described above has a crystallization temperature (Tc) between 0 and 125° C. In further embodiments, the Tc is between 5° C. and 110° C. In other embodiments, the Tc is between 5° C. and 100° C., between 5° C. and 90° C., between 5° C. and 80° C., between 10° C. and 50° C., between 50° C. and 80° C., or between 60° C. and 80° C.

In one embodiment, the polymer may comprise a glass transition temperature (Tg) as measured by ASTM E 1356 of 5° C. or less; preferably of 0° C. or less; or −10° C. or less; or −15° C. or less. Alternatively, the Tg will be between −65° C. to 30° C. or between −40° C. and 0° C. or between −5° C. and −15° C.

The propylene polymer can have a viscosity of less than 50,000 mPa sec when measured at 190° C. using a Brookfield viscometer. For example, the viscosity of the propylene polymer can be less than about 35,000 mPa sec, less than 35,000 mPa sec, less than 25,000 mPa sec, less than 20,000 mPa sec, less than 15,000 mPa sec, less than 10,000 mPa sec, less than 5,000 mPa sec, or less than 1,000 mPa sec. In one or more embodiments, the viscosity of the propylene polymer can range from a low of about 500 mPa sec, 2,000 mPa sec, or 6,000 mPa sec to a high of about 10,000 mPa sec, 15,000 mPa sec, 30,000 mPa sec, or 35,000 mPa sec. In one or more embodiments, the viscosity of the propylene polymer can range from a low of about 500 mPa sec, 1,200 mPa sec, or 3,200 mPa sec to a high of about 8,000 mPa sec, 12,000 mPa sec, or 24,000 mPa sec.

In one or more embodiments, the propylene copolymer further has an intrinsic viscosity [η], measured at 135° C. in decalin, of from 0.1 to 5 dl/g, 0.1 to 2 dl/g, 0.1 to 1 dl/g, 0.1 to 0.8 dl/g, 0.1 to 0.5 dl/g, or 0.2 to 0.4 dl/g.

In some embodiments, the second polymer component comprises a polyolefin adhesive (“POA”), wherein the POA comprises a propylene content of at least 50 wt %, a heat of fusion from 2 to 120 J/g, a weight average molecular weight (Mw) from 15,000 to 250,000, and/or a weight average molecular weight/number average molecular weight ratio (Mw/Mn, or MWD) from about 1.8 to 10.

The POA may also comprise a copolymer comprising at least 70 wt % of units derived from propylene and from about 1 to about 30 wt % of units derived from ethylene or at least one C₄ to C₁₂ alpha-olefin, wherein the copolymer has a molecular weight of from about 15,000 to about 100,000 and a heat of fusion between about 10 and about 100 J/g. In one or more embodiments, the POA comprises a metallocene catalyzed copolymer of propylene and at least one monomer.

The polyolefin polymers may be prepared by any conventional synthesis processes. Preferably, polypropylene is prepared utilizing one or more catalysts, which are typically metallocene catalysts, by polymerization of an olefin monomer. The propylene polymers described herein may be produced in any known polymerization process. Polymerization methods include high pressure, slurry, gas, bulk, suspension, supercritical, or solution phase, or a combination thereof, preferably using a single-site metallocene catalyst system. The catalysts can be in the form of a homogeneous solution, supported, or a combination thereof. Polymerization may be carried out by a continuous, a semi-continuous or batch process and may include use of chain transfer agents, scavengers, or other such additives as deemed applicable. By continuous is meant a system that operates (or is intended to operate) without interruption or cessation. For example a continuous process to produce a polymer would be one where the reactants are continually introduced into one or more reactors and polymer product is continually withdrawn. In one embodiment, the propylene polymer described herein is produced in a single or multiple polymerization zones using a single polymerization catalyst. Suitable methods and catalyst systems used for the production of propylene polymers such as those described herein may be found in, for example, the disclosures of U.S. Pat. Nos. 7,294,681 and 7,524,910, which are incorporated herein by reference.

### Blends of the First and Second Polymer Component

The adhesive polymer blends of the present invention comprise the first polymer component and the second polymer component. In one or more embodiments, the adhesive blends comprise from about 5 to about 50 wt % of the first polymer component and from about 50 to about 95 wt % of the second polymer component, based upon the overall weight of the adhesive polymer blend. In further embodiments, the blends may comprise from about 5 to about 45 wt %, or from about 10 to about 40 wt %, or from about 10 to about 35 wt % of the first polymer component, and from about 55 to about 95 wt %, or from about 60 to about 90 wt %, or from about 65 to about 90 wt % of the second polymer component, based upon the overall weight of the adhesive polymer blend.

Each of the first and second polymer components may comprise one or more additives, and those additives are considered as part of the total weight of that component for the purposes of the previous weight percentage ranges. The types and amounts of additives used will vary widely depending upon the intended use of the adhesive blend, and such adjustments are considered to be within the abilities of those skilled in the art. While specific examples of adhesive formulas and component ranges are set forth herein, they are not intended to be limiting where a formulation outside of the stated bounds would be within the knowledge of one skilled in the art of adhesive formulation. In one embodiment, the adhesive polymer blends described herein may comprise from about 0.1 to about 40 wt % additives, based on the total weight of the overall adhesive blend composition. In further embodiments, the adhesive blends may comprise from about 5 to about 25 wt % additives, based on the total weight of the overall adhesive blend composition.

### Additives

A variety of additives may be employed in the adhesive blend formulations described herein depending upon the performance characteristics required by a particular application. Examples of such additives include, but are not limited to, tackifiers, waxes, functionalized polymers such as acid modified polyolefins, and/or anhydride modified polyolefins, antioxidants, oils, compatabilizers, fillers, adjuvants, adhesion promoters, plasticizers, low molecular weight polymers, block, antiblock, pigments, processing aids, UV stabilizers, neutralizers, lubricants, surfactants, nucleating agents, flexibilizers, rubbers, optical brighteners, colorants, diluents, viscosity modifiers, and oxidized polyolefins. Additives may be combined with one or both of the first or second polymer components and/or may be combined with the blend of the first and second polymer components as further individual components, in masterbatches, or in any combination thereof.

### Tackifiers

Tackifiers, i.e., hydrocarbon resins, include conventional tackifiers known to those skilled in the art. Exemplary tackifiers include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, and hydrogenated rosin esters. The tackifiers may or may not be functionalized. In some embodiments, the tackifier is hydrogenated. In the same or other embodiments, the tackifier is non-polar. Non-polar means that the tackifier is substantially free of monomers having polar groups. Preferably the polar groups are not present; however, if they are preferably they are not present at more that 5 wt %, preferably not more that 2 wt %, even more preferably no more than 0.5 wt %. In some embodiments the tackifier has a softening point (Ring and Ball, as measured by ASTM E-28) of 50° C. to 140° C., preferably 80° C. to 130° C.

The tackifier, if present, is typically present in amounts of from about 1 wt % to about 30 wt %, or from about 5 wt % to 25 wt %, or from about 10 wt % to about 20 wt %, based on the weight of the overall adhesive blend composition.

In one or more embodiments of the present invention, the first polymer component comprises a tackifier, while the second polymer component is substantially free of tackifier. “Substantially free of” is used herein to mean that, while some impurities may exist at very low levels in the second polymer component that have tackifying properties, no tackifier compositions are deliberately added to the second polymer component. In such embodiments, the first polymer component may comprise one or more tackifiers, where the tackifiers are present in an amount of from about 10 to about 75 wt %, or from about 20 to about 70 wt %, or from about 30 to about 65 wt %, or from about 40 to about 60 wt %, based on the total weight of the first polymer component.

Exemplary tackifiers are commercially available as the ESCOREZ™ family, e.g., 5300, 5320, 5340, 5380, 5690, 5600, and 5620, or the Oppera™ series of polymeric additives from ExxonMobil Chemical Company.

### Waxes

The adhesive blend compositions described herein may comprise one or more waxes. Waxes may include natural or synthetic waxes, polypropylene waxes, and polyethylene waxes. Waxes include Fischer Tropsch waxes, available from, for example, Sasol Corporation or Bareco Corporation, polyethylene waxes, available from, for example, Baker Petrolite Corporation, Honeywell Corporation, or Eastman Corporation, or oxidized high density polyethylene homopolymer waxes, available from, for example, Honeywell Corporation.

In particular, waxes suitable for use in the invention include paraffin waxes, microcrystalline waxes, high density low molecular weight polyethylene waxes, by-product polyethylene waxes, oxidized Fischer Tropsch waxes and functionalized waxes such as hydroxyl stearamide waxes and fatty amide waxes. It is common in the art to use the term “synthetic high melting point waxes” to include high density low molecular weight polyethylene waxes, by-product polyethylene waxes and Fischer Tropsch waxes. In some embodiments, waxes useful in the practice of the invention have a melting point of from about 60° C. to about 120° C. and have an oil content of less than about 0.5 wt % based on the weight of the wax.

The wax may have a viscosity at 140° C. of from about 100 mPa-s to about 10,000 mPa-s and at least one of (a)-(d): (a) mettler drop point as determined by ASTM-D3954-94 of greater than 110° C.; (b) a congealing point as determined by ASTM D-938 of greater than 110° C.; (c) a ring and ball softening point as determined by ASTM E-28 of greater than 110° C.; or (d) a peak melt temperature as determined by DSC of greater than 110° C.

One or more waxes, if present, are typically present in amounts of from about 0.01 wt % to about 30 wt %, or from about 0.1 wt % to 20 wt %, or from about 1 wt % to about 10 wt %, based on the weight of the overall adhesive blend composition.

### Functionalized Components

The adhesive blend compositions described herein may comprise one or more functionalized components. Typically, the component to be functionalized is combined with a free radical initiator and a grafting monomer or other functional group (such as maleic acid or maleic anhydride) and is heated to react the monomer with the polymer, copolymer, oligomer, etc. to form the functionalized component. Multiple methods exist in the art for functionalizing polymers that may be used with the polymers described here. These include selective oxidation, free radical grafting, ozonolysis, epoxidation, and the like.

Examples of suitable functionalized components for use in the invention include, but are not limited to, functionalized olefin polymers, (such as functionalized C₂-C₄₀ homopolymers, functionalized C₂-C₄₀ copolymers, or functionalized higher Mw waxes), functionalized oligomers (such as functionalized low Mw waxes or functionalized tackifiers), beta nucleating agents and combinations thereof.

Functionalized olefin polymers and copolymers useful in this invention include maleated polyethylene, maleated metallocene polyethylene, maleated metallocene polypropylene, maleated ethylene propylene rubber, maleated polypropylene, maleated ethylene copolymers, functionalized polyisobutylene (typically functionalized with maleic anhydride to form a succinic anhydride), and the like.

Functionalized waxes useful as functionalized components herein include those modified with an alcohol, an acid, a ketone, an anhydride and the like. Examples include waxes modified by methyl ketone, maleic anhydride or maleic acid. Some functionalized waxes useful herein include maleated polypropylene (such as available from Chusei under the tradename MAPP 40); maleated metallocene waxes (such as TP LICOCENE PP1602 available from Clariant, in Augsburg, Germany); maleated polyethylene waxes and maleted polypropylene waxes (available from Eastman Chemical in Kingsport, Tenn. under the trade names EPOLENE C-16, EPOLENE C-18, EPOLENE E43, EPOLENE G-3003); maleated polypropylene wax (such as LICOMONT AR 504 available from Clariant); grafted functional polymers (available from Dow Chemical Co., under the trade names AMPLIFY EA 100, AMPLIFY EA 102, AMPLIFY 103, AMPLIFY GR 202, AMPLIFY GR 205, AMPLIFYGR 207, AMPLIFY GR 208, AMPLIFY GR 209, and AMPLIFY VA 200); maleated ethylene polymers (available from Baker Hughes under the trade names CERAMER 1608, CERAMER 1251, CERAMER 67, and CERAMER 24); and ethylene methyl acrylate co and terpolymers.

Useful waxes include polypropylene waxes having an Mw of 15,000 or less, preferably from 3000 to 10,000, and a crystallinity of 5% or more, preferably 10% or more, and having a functional group content (preferably maleic anhydride) of up to 10 wt %.

Additional functionalized polymers for use as functional components herein include A-C X596A, A-C X596P, A-C X597A, A-C X597P, A-C X950P, A-C X1221, A-C 395A, A-C 395A, A-C 1302P, A-C 540, A-C 54A, A-C 629, A-C 629A, and A-C 307, and A-C 307A, all available from Honeywell.

UNILIN long chain alcohols, available from Baker Hughes, are also useful as functionalized components herein, particularly UNILIN 350, UNILIN 425, UNILIN 550, and UNILIN 700.

UNICID linear, primary carboxylic acids, available from Baker Hughes, are also useful as functionalized components herein, particularly UNICID 350, UNICID 425, UNICID 550, and UNICID 700.

Preferred functionalized hydrocarbon resins that may be used as functionalized components in this invention include those described in WO 03/025084, WO 03/025037, WO 03/025036, and EP 1 295 926 A1, each of which is incorporated herein by reference.

In one or more embodiments, a hydrocarbon resin is functionalized with an unsaturated acid or anhydride containing at least one double bond and at least one carbonyl group and used as the functionalized component of this invention. Hydrocarbon resins that can be functionalized are listed above as tackifiers. Representative acids include carboxylic acids, anhydrides, esters and their salts, both metallic and non-metallic. Preferably the organic compound contains an ethylenic unsaturation conjugated with a carbonyl group (—C═O). Examples include maleic, fumaric, acrylic, methacrylic, itaconic, crotonic, alpha methyl crotonic, and cinnamic acids as well as their anhydrides, esters and salt derivatives. Particularly preferred functional groups include maleic acid and maleic anhydride. The unsaturated acid or anhydride may be present in amounts of from about 0.1 weight % to about 10 wt %, or about 0.5 weight % to about 7 weight %, or about 1 to about 4 weight %, based upon the weight of the hydrocarbon resin and the unsaturated acid or anhydride. In one or more embodiments the unsaturated acid or anhydride comprises a carboxylic acid or a derivative thereof selected from the group consisting of unsaturated carboxylic acids, unsaturated carboxylic acid derivatives selected from esters, imides, amides, anhydrides and cyclic acid anhydrides or mixtures thereof.

In some embodiments, the functionalized component is present in the adhesive blend compositions described herein in amounts of from 0.01 wt % to 10 wt %, or from 0.01 wt % to 8 wt %, or from 0.1 wt % to 6 wt %, or from 0.5 wt % to 5 wt %, or from 1 wt % to 4 wt %, based upon the weight of the overall adhesive blend composition. In other embodiments, a functionalized component is not present in the adhesive blend composition.

### Antioxidants

The adhesive blend compositions described herein may comprise one or more antioxidants. Examples of suitable antioxidants include, but are not limited to, quinoleins, e.g. trimethylhydroxypuinolein (TMQ); imidazoles, e.g. zincmercapto toluyl imidazole (ZMTI); and conventional antioxidants, such as phenols, hindered phenols, lactones, phosphates, and hindered amines. Further suitable antioxidants are commercially available from, for example, Ciba Geigy Corp. under the trade names Irganox 1010, Irganox 1035, Irganox 1076, Irganox 3790, Irganox B225, Irgafos 126, Irgafos 168, Irgastab 410, and Chimassorb 944.

In some embodiments, the one or more antioxidants are present in the adhesive blend compositions described herein in amounts of from 0.01 wt % to 5 wt %, or from 0.05 wt % to 3 wt %, or from 0.075 wt % to 2 wt %, or from 0.1 wt % to 1.5 wt %, or from 0.1 wt % to 1 wt %, based upon the weight of the overall adhesive blend composition. In other embodiments, an antioxidant is not present in the adhesive blend composition.

### Process Oils

In one or more embodiments of the present invention, one or more process oils may be added to the adhesive blend compositions described herein. As used herein, the term “process oil” means both petroleum derived process oils and synthetic plasticizers.

Examples of process oils suitable for use in the present invention include, but are not limited to, paraffinic or naphthenic oils such as Primol 352 or Primol 876, available from ExxonMobil Chemical France, S.A. in Paris, France, and Nyflex naphthenic oils available from Nynas A B, Stockholm, Sweden. Further process oils suitable for use in the present invention include aliphatic naphthenic oils, white oils, and the like. Exemplary plasticizers and/or adjuvants include mineral oils, polybutenes, phthalates and the like. In one or more embodiments, the plasticizers may include phthalates such as diisoundecyl phthalate (DIUP), diisononylphthalate (DINP), dioctylphthalates (DOP), and polybutenes, such as Parapol 950 and Parapol 1300 available from ExxonMobil Chemical Company in Houston, Tex. Further useful plasticizers include those described in WO0118109A1 and U.S. Application Pub. No. 2004/0106723, which are incorporated by reference herein.

In one or more embodiments, the adhesive blend compositions described herein may comprise from about 0.1 to about 30 wt %, or from about 0.5 to about 25 wt %, or from about 1 to about 20 wt %, or from about 1 to about 10 wt % of the optional process oil component, based upon the weight of the overall adhesive blend composition.

### Other Additives

Fillers include conventional fillers known to those skilled in the art, including titanium dioxide, calcium carbonate, barium sulfate, silica, silicon dioxide, carbon black, sand, glass beads, mineral aggregates, talc, and/or clay.

Adhesion promoters include conventional adhesion promoters known to those skilled in the art. Adhesion promoters include polar acids, polyaminoamides, such as Versamid 115, 125, 140, available from Henkel, urethanes, such as isocyanate/hydroxy terminated polyester systems, e.g., bonding agent TN/Mondur Cb-75 (Miles, Inc., coupling agents, such as silane esters.

Low Mn polymers include conventional low Mn polymers known to those skilled in the art. Preferred low Mn polymers include polymers of lower alpha olefins such as propylene, butene, pentene, and hexene. A particularly preferred polymer includes polybutene having an Mn of less than 1000. An example of such a polymer is available under the trade name PARAPOL™ 950 from ExxonMobil Chemical Company. PARAPOL™ 950 is a liquid polybutene polymer having an Mn of 950 and a kinematic viscosity of 220 cSt at 100° C., as measured by ASTM D 445. In some embodiments polar and non-polar waxes are used together in the same composition.

In some embodiments, of the present invention, the first and second polymer components are physically compatible. By “compatible” is meant that the two components, when mixed, form a homogeneous blend. In other embodiments; however, the first and second polymer components may be incompatible. Such incompatibility may lead to a two-phase blend in which each phase has differential performance For example, one phase may have good peel performance while the other phase has good creep retention. Possible configurations of such a two phase blend include streaking, “candy striping”, or an “islands in the sea” arrangement. Persons of ordinary skill in the art will recognize that such configurations may be desirable, and in fact preferred, depending on the intended end use of the blend.

In some situations and for some intended uses; however, incompatibility of the first and second polymer components is undesirable and a homogeneous blend is preferred. In such situations, one or both of the first and second polymer components may further comprise a compatibilizer or adhesion promoter. Suitable compatabilizers are known in the art and include, but are not limited to, ethylene vinyl acetate (EVA), ethylene n-butyl acrylate (EnBA), ethylene methyl methacrylate (EMMA), silanes, titanates, organosylane, acrylics, acids, anhydrides, epoxy resins, hardening agents, polyamides, methylacrylates, epoxies, phenolic resins, polyisobutylene, aminoalkyl, mercaptoalkyl, epoxyalkyl, ureidoalkyl, carboxy, acrylate and isocyanurate functional silanes, mercaptopropyltrimethoxysilane, glycidoxpropyltrimethoxysilane, aminopropyltriethoxysilane, aminoethylaminopropyltrimethoxysilane, ureidopropyltrimethyloxysilane, bis-gamma-trimethoxysilyl-propylurea, 1,3,5-tris-gamma- trimethoxysilylpropylisocyanurate, bis-gamma-trimethoxysilylpropylmaleate, fumarate and gamma-methacryloxypropyltrimethoxysilane, aminopropyltriethoxysilane, and combinations and derivatives thereof.

In one or more embodiments herein, the adhesive blend compositions of the invention comprise at least a tackifier. In other embodiments, the blend compositions comprise a tackifier and one or more other additives. In further embodiments, the blend compositions comprise at least 3, at least 4, at least 5, at least 6, or 7 or more additives. In some embodiments, the blends comprise at least a tackifier and an oil, or at least a tackifier, an oil, and an antioxidant.

### Processes for Forming Adhesive Blend Compositions

The present invention further includes processes for forming the adhesive blend compositions described herein. In one or more embodiments, the invention comprises an in-line continual or continuous process for forming the adhesive blend compositions described herein, where the process comprises providing, in a first vessel, the first polymer component; providing, in a second vessel, the second polymer component; providing one or more substrates to which the blend composition is to be applied; extracting the first and second polymer components of the blend from their respective vessels; and mixing the first and second components to form an adhesive blend composition before the composition is applied to the substrate. The term “vessel,” as used herein, is meant to include any manner of container, receptacle, tank, or other apparatus suitable for use in a chemical or other manufacturing process to hold solid or liquid ingredients used in the process, including devices such as extruders, mixers, drum unloaders, etc. As used herein, the term “extracting” is meant to include any method of removing the contents of a vessel and transporting those contents to another point in a process, and may include movement of the vessel's contents caused by forces such as gravity, differences in pressure or temperature, operation of valves or pumps, etc.

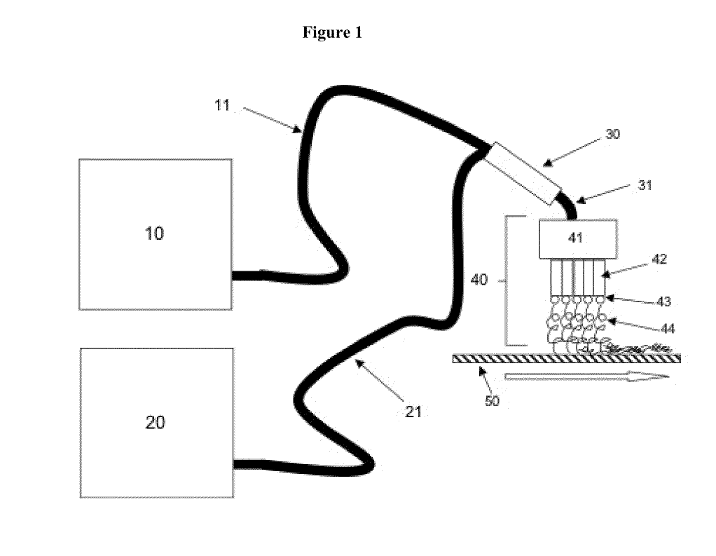

The first and second polymer components are extracted from their respective vessels and mixed at some point in the process prior to application of the adhesive blend to the substrate or substrates. It is contemplated that the mixing step may be located anywhere in the process between the first and second vessels and the application device used to apply the adhesive blend to the substrate. For example, the mixer may be directly adjacent to the outlets of the first and second vessels, such that the components are mixed before being transported to the application device. Alternatively, the first and second components may be extracted and transported to a mixer that is located directly adjacent to or is a part of the application device. The processes of the present invention may be adapted to include additional components such as one or more additional vessels, remote mixing stations, extruders, etc. Possible process configurations include, but are not limited to, those depicted in FIGS. 1 through 4 appended hereto.

In FIG. 1, the first and second polymer components are contained in vessels 10 and 20, respectively. The polymer components are transported from their respective vessels via lines 11 and 21 to mixing device 30. The adhesive polymer blend formed in mixer 30 is then transported via line 31 to application device 40, which in this case comprises an applicator head (or gun) 41, valves 42, nozzles 43, and applied adhesive 44. The adhesive polymer blend travels through application device 40 and is applied to the substrate 50.

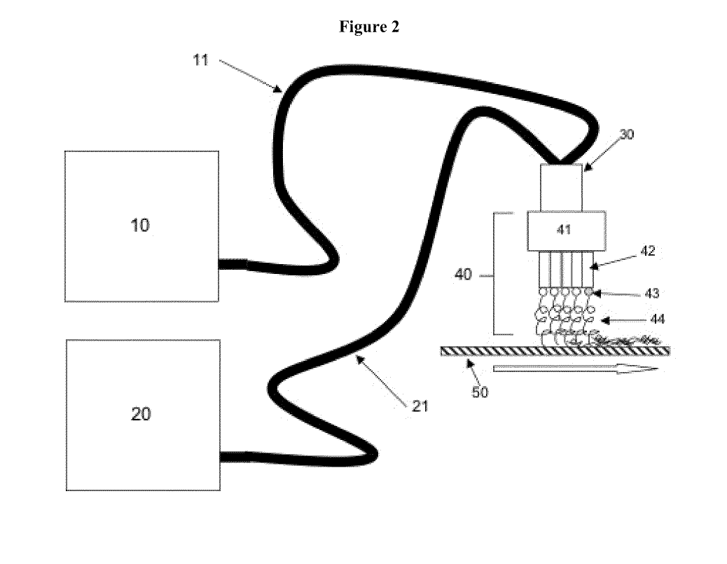

FIG. 2 depicts a process similar to that shown in FIG. 1, except that mixing device 30 is attached to application device 40, such that the adhesive polymer blend travels directly from mixing device 30 into application device 40.

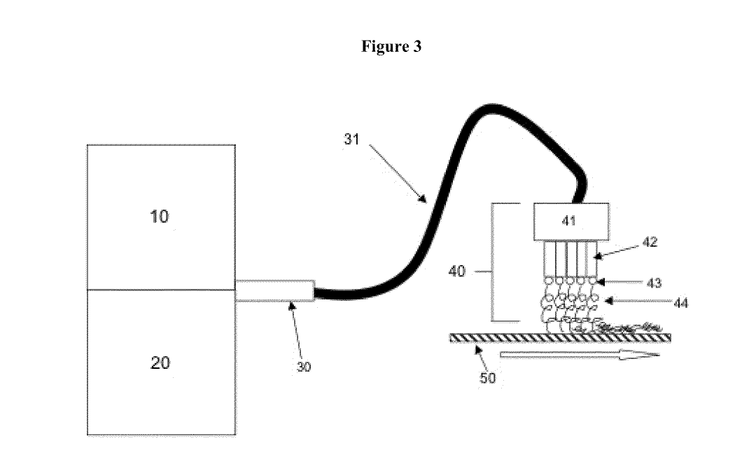

Another alternate configuration is shown in FIG. 3, in which the mixing device 30 is located directly adjacent to vessels 10 and 20, such that the first and second polymer components are fed directly from the vessels into mixing device 30. From mixing device 30, the adhesive polymer blend formed therein is then transported via line 31 to application device 40 and applied to substrate 50, much as in FIG. 1.

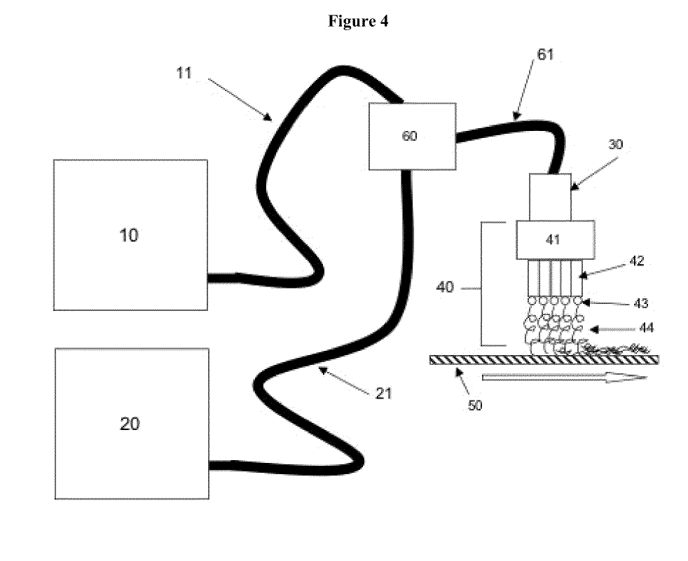

A further embodiment is illustrated by FIG. 4. The process shown in FIG. 4 is similar to that shown in FIG. 2, except that it further comprises a metering device 60, such that the first and second polymer components are transported from vessels 10 and 20, respectively, via lines 11 and 21, respectively, to metering device 60. Metering device 60 then meters the first and second polymer components so that they are delivered to the mixing device 30 via line 61 in the desired ratio necessary to form the adhesive blend composition. The blend composition then moves from mixing device 30 into application device 40 and is applied to substrate 50.

In some embodiments of the invention, the additives which are to be included in the adhesive polymer blend are provided as part of the first polymer component and/or the second polymer component such that no additional additives are incorporated elsewhere in the process. In other embodiments, however, it may be desirable to incorporate one or more additives by adding them separately to the mixing device 30, the application device 40, the metering device 60, or along one or more of lines 11, 21, 31, or 61. Although such embodiments are not shown, they are contemplated herein and are considered to be part of the invention.

Additionally, it may be desirable to include further polymer components beyond the first and second polymer components, such as for example a third, fourth, fifth, etc. polymer component. Although only two vessels are depicted in the Figures, any number of polymer components and vessels may be employed depending upon the desired polymer formulation and use. Similarly, one or more additives may be held in an additional vessel or vessels similar to those depicted, such that the additives are incorporated into the process in a manner similar to that described herein with respect to the first and second polymer components. Such processes comprising three or more polymer components and/or three or more vessels are contemplated herein and considered to be part of the invention.

Any mixing device capable of mixing the polymer components and additives described herein in a continual or continuous manner is suitable for use in the processes of the present invention. Such mixers are well known in the art and include, but are not limited to, agitators, extruders, kneaders, paddle mixers, planetary mixers, impeller mixers, ribbon mixers, conical or screw mixers, static mixers, single or twin rotor mixers, turbine mixers, and spiral mixers. In one embodiment, the mixer is a static mixer. In another embodiment, the mixer is a spiral mixer.

The adhesive blend compositions of the present invention may be applied to a wide variety of substrates. Such substrates include any material that can be at least partially adhered to itself or another material by the adhesive blend compositions described herein. Illustrative substrates include, but are not limited to, paper, glass, wood, plastic, metal, cloth, nonwoven fabrics, construction or roofing materials, automotive parts, etc. The substrates may take any form, such as flat sheets, fabrics, or films, or other three dimensional objects such as containers, tubes, molded articles, etc. The substrates may comprise one material or multiple materials, such as in multilayered films or fabrics. The adhesive blends of the invention are particularly suited to nonwoven applications and substrates, including clothing, diapers and other personal hygiene articles, medical gowns and sheets, etc.

The inventive processes described herein are advantageous because they allow for increased flexibility in formulating and applying adhesive polymer compositions. By providing components of the blend individually and blending them in an in-line continuous process, adhesive blends can be tailored to various process conditions, substrates, and end use applications in real time, allowing for virtually unlimited adjustment and versatility in formulating the adhesive polymer blends. Additionally, by incorporating the amount of tackifier desired in the overall blend into the first polymer component, the second polymer component can be provided free of tackifier (but may comprise other additives), thus reducing or eliminating storage and handling issues previously experienced in the industry.

### Experimental Methods

The following experimental procedures were used to measure the parameters that are disclosed in this specification.

Adhesive melt viscosity was measured using a Brookfield digital viscometer according to ASTM D-3236.

Mz, Mw and Mn can be measured using gel permeation chromatography (GPC), also known as size exclusion chromatography (SEC). This technique utilizes an instrument containing columns packed with porous beads, an elution solvent, and detector in order to separate polymer molecules of different sizes. Measurement of molecular weight by SEC is well known in the art and is discussed in more detail in, for example, Slade, P. E. Ed., Polymer Molecular Weights Part II, Marcel Dekker, Inc., NY, (1975) 287-368; Rodriguez, F., Principles of Polymer Systems 3rd ed., Hemisphere Pub. Corp., NY, (1989) 155-160; U.S. Pat. No. 4,540,753; Verstrate et al., Macromolecules, vol. 21, (1988) 3360; T. Sun et al., Macromolecules, Vol. 34, (2001) 6812-6820, incorporated herein by reference; and references cited therein.

The branching index (g′) was measured using SEC with an on-line viscometer (SEC-VIS) and is reported as g′ at each molecular weight in the SEC trace. The branching index g′ is defined as:

$${g}^{′} = \frac{{η}_{b}}{{η}_{l}}$$

where η_{b} is the intrinsic viscosity of the branched polymer and η₁ is the intrinsic viscosity of a linear polymer of the same viscosity-averaged molecular weight (Mv) as the branched polymer. η₁=KMvα, K and α were measured values for linear polymers and should be obtained on the same SEC-DRI-LS-VIS instrument as the one used for branching index measurement. For polypropylene samples presented in this invention, K=0.0002288 and α=0.705 were used. Linear polymers selected as standards for comparison should be of the same viscosity average molecular weight, monomer content and composition distribution. Linear character for polymers containing C₂ to C₁₂ monomers is confirmed by Carbon-13 NMR using the method of Randall (Rev. Macromol. Chem. Phys., C29 (2&3), p. 285-297). Linear character for C₁₁ and above monomers is confirmed by GPC analysis using a MALLS detector. For example, for a copolymer of propylene, the NMR should not indicate branching greater than that of the co-monomer (i.e. if the comonomer is butene, branches of greater than two carbons should not be present). For a homopolymer of propylene, the GPC should not show branches of more than one carbon atom. When a linear standard is desired for a polymer where the comonomer is C₉ or more, one can refer to T. Sun, P. Brant, R. R. Chance, and W. W. Graessley, Macromolecules, Volume 34, Number 19, 6812-6820, (2001) for protocols on determining standards for those polymers (incorporated herein by reference). In the case of syndiotactic polymers, the standard should have a comparable amount of syndiotacticity as measured by Carbon 13 NMR.

The viscosity averaged g′ was calculated using the following equation:

$${g}_{vis}^{′} = \frac{\sum {{c}_{i} [ {η}_{i} ]}_{b}}{\sum {c}_{i} {KM}_{i}^{α}}$$

where cᵢ is the polymer concentration in the slice i in the polymer peak, and [ηᵢ]_{b} is the viscosity of the branched polymer in slice i of the polymer peak, and Mᵢ is the weight averaged molecular weight in slice i of the polymer peak measured by light scattering, K and α are as defined above.

Melting point (Tm), peak crystallization temperature (Tc), glass transition temperature (Tg), and heat of fusion (Hf) and percent crystallinity were determined by differential scanning calorimetry (DSC) by the following procedure according to ASTM D3418-03 using a TA Instruments model Q100 or Q200. Samples weighing approximately 5-10 mg are sealed in aluminum hermetic sample pans. The DSC data were recorded by first gradually heating the sample to 200° C. at a rate of 10° C./minute. The sample was kept at 200° C. for 2 minutes, and then cooled to −90° C. at a rate of 10° C/minute, followed by an isothermal for 2 minutes and heating to 200° C. at 10° C./minute. Both the first and second cycle thermal events are recorded. Tc, Tm, and Hf are measured on the second melt. Areas under the melting peaks are measured and used to determine the heat of fusion and the degree of crystallinity. The percent crystallinity (X %) is calculated using the formula, X %=[area under the curve (Joules/gram)/B (Joules/gram)]*100, where B is the heat of fusion for the homopolymer of the major monomer component. These values for B are to be obtained from the Polymer Handbook, Fourth Edition, published by John Wiley and Sons, New York 1999. A value of 208 J/g (B) is used as the heat of fusion for 100% crystalline polypropylene. The amorphous content (%) is calculated using the formula (100—percent of crystallinity). The melting point, glass transition temperature, heat of fusion, and crystallization temperature are measured and reported during the second heating cycle (or second melt).

Some of polymer blends produced show a secondary melting/cooling peak overlapping with the principal peak, which peaks are considered together as a single melting/cooling peak. The highest of these peaks is considered the peak melting temperature/crystallization point. For the amorphous polymers, having comparatively low levels of crystallinity, the melting temperature is typically measured and reported during the first heating cycle. Prior to the DSC measurement, the sample was aged (typically by holding it at ambient temperature for a period up to about 2 days) or annealed to maximize the level of crystallinity.

Shore A and Shore C hardness. The determination of the Shore A and Shore C hardness of the polymer is according to ASTM D2240. In this version of the method a portion of the sample is tested at room temperature. The data is recorded initially and 5 seconds after the indentation is created in the sample.

Further embodiments of the present invention are set forth in the following lettered paragraphs:
A. A process for forming an adhesive blend composition, comprising providing, in a first vessel, a first component of the blend, wherein the first component comprises one or more styrenic block copolymers and one or more hydrocarbon tackifier resins; providing, in a second vessel, a second component of the blend, wherein the second component comprises a polyolefin polymer; providing a substrate to which the blend composition is to be applied; extracting the first and second components of the blend from their respective vessels and continuously or continually mixing the first and second components to form an adhesive blend composition; and applying the adhesive blend composition to the substrate.
B. The process of paragraph A, wherein the second component is substantially free of hydrocarbon tackifier resins.
C. The process of paragraph A or B, wherein the polyolefin polymer has a propylene content of at least 50 wt %, a heat of fusion from about 2 to about 120 J/g, and a weight average molecular weight (Mw) from about 15,000 to about 250,000.
D. The process of any one of paragraphs A through C, wherein the first component, the second component, or both of the first and second components of the blend additionally comprise one or more additives.
E. The process of any one of paragraphs A through D, wherein the one or more styrenic block copolymers are selected from styrene-isoprene block copolymers, styrene-butadiene block copolymers and styrene-isoprene-butadiene block copolymers.
F. The process of any one of paragraphs A through E, wherein the one or more styrenic block copolymers are selected from radial styrene-isoprene block copolymers and radial styrene-butadiene block copolymers.
G. The process of any one of paragraphs A through F, wherein the one or more hydrocarbon tackifier resins have a ring-and-ball softening point of from about 50 to about 140 ° C.
H. The process of any one of paragraphs A through G, wherein the second component comprises a polyolefin copolymer comprising a propylene content of at least 70 wt %, a comonomer content of from about 1 to about 30 wt %, a weight average molecular weight (Mw) of about 15,000 to about 100,000, and a heat of fusion of about 10 to about 100 J/g; and wherein the comonomer is ethylene and/or a C4 to C12 alpha-olefin.
I. The process of any one of paragraphs A through H, further comprising providing, in one or more additional vessels, one or more additional components of the blend, which are extracted from their respective vessels and mixed together with the first and second components of the blend during step (d).
J. The process of any one of paragraphs A through I, wherein the first and second components of the blend are mixed in a static mixer.
K. The process of any one of paragraphs A through J, wherein the first and second components of the blend are mixed in a spiral mixer.
L. The process of any one of paragraphs A through K, wherein the first component of the blend comprises two or more additives.
M. The process of any one of paragraphs A through L, wherein the second component of the blend comprises two or more additives.
N. The process of any one of paragraphs A through M, wherein the adhesive blend composition comprises three or more additives.
O. The process of any one of paragraphs A through N, wherein the adhesive blend composition comprises four or more additives.
P. The process of any one of paragraphs A through O, wherein the additives are selected from tackifiers, waxes, functionalized polymers such as acid modified polyolefins, and/or anhydride modified polyolefins, antioxidants, oils, compatabilizers, fillers, adjuvants, adhesion promoters, plasticizers, low molecular weight polymers, block, antiblock, pigments, processing aids, UV stabilizers, neutralizers, lubricants, surfactants, nucleating agents, flexibilizers, rubbers, optical brighteners, colorants, diluents, viscosity modifiers, and oxidized polyolefins.
Q. The process of any one of paragraphs A through P, wherein the adhesive blend composition comprises from about 5 to about 45 wt % of the first component.
R. The process of any one of paragraphs A through Q, wherein the adhesive blend composition comprises from about 10 to about 40 wt % of the first component.
S. The process of any one of paragraphs A through R, wherein the additives comprise from about 0.1 to about 40 wt % of the adhesive blend composition.
T. The process of any one of paragraphs A through S, wherein the additives comprise from about 5 to about 25 wt % of the adhesive blend composition.
U. The process of any one of paragraphs A through T further comprising: (a) providing, in a third vessel, a third component of the blend, wherein the third component comprises one or more styrenic block copolymers; (b) extracting the first and second and third components of the blend from their respective vessels and continuously or continually mixing the first and second and third components to form an adhesive blend composition before the composition is applied to the substrate.
V. The process of any one of paragraphs A through U wherein the first and second component are mixed and applied using a bi-alternating method comprising:
   a) forming a first intermittent component predominantly comprising the first component;
   b) applying the first intermittent component to a first substrate area;
   c) forming a second intermittent component predominantly comprising the second component; and
   d) applying the second intermittent component to a second substrate area.
W. The process of paragraph V wherein the substrate is a diaper and the first substrate area comprises at least one elastic member zone and the second substrate area comprises at least one non-elastic member zone.
X. An adhesive blend composition prepared according to any one of paragraphs A through W.
Y. A substrate at least partially coated with an adhesive blend composition prepared according to any one of paragraphs A through W.

### EXAMPLES

Embodiments of the present invention are further illustrated with reference to the following Examples.

The following abbreviations or designations are used in the Tables below:
“FPC1” is an SIS block copolymer-based elastic attachment adhesive. FPC1 comprises HCR1, SBC1, PO, HCR5, and AO.
“FPC2” is an SIS block copolymer-based construction adhesive. FPC2 comprises HCR1, SBC2, PO, HCR5, and AO.
“FPC3” is an SIS block copolymer-based elastic attachment adhesive. FPC3 comprises HCR1, SBC2, PO, HCR5, and AO.
“FPC4” is an SIS block copolymer-based elastic attachment adhesive. FPC4 comprises HCR1, HCR2, HCR3, SBC3, PO, HCR5, and AO.
“FPC5” is a metallocene-catalyzed polyethylene based adhesive. FPC5 comprises HCR1, HCR4, PE, PO, EW, and AO.
“SPC1” is a propylene-hexene copolymer having a hexene content of approximately 12 wt % and a viscosity of approximately 4000 cPs at 177° C.
“SPC2” is a propylene-hexene copolymer having a hexene content of approximately 13 wt % and a viscosity of approximately 4000 cPs at 177° C.
“MaPP” is a polypropylene-maleic anhydride copolymer from Honeywell, having a viscosity at 190° C. of less than 400 mPas, and Mettler drop point of 143° C.
“AO” is phenolic antioxidant having a molecular weight of approximately 1178 g/mol and a density of about 1.15 g/cm³ at 20° C.
“HCR1” is a hydrogenated cycloaliphatic tackifier resin having a softening point of about 103° C. and an Mw of about 400 g/mol.
“HCR2” is a hydrogenated aromatic modified cycloaliphatic tackifier resin having a softening point of about 103° C. and an Mw of about 520 g/mol.
“HCR3” is a hydrogenated aromatic modified cycloaliphatic tackifier resin having a softening point of about 118° C. and an Mw of about 500 g/mol.
“HCR4” is a hydrogenated hydrocarbon tackifier resin having a softening point of about 100° C. and an Mw of about 1000 g/mol.
“HCR5” is a purified aromatic hydrocarbon resin having a softening point of about 159° C. and an Mw of about 8600 g/mol.
“SBC1” is an SIS triblock copolymer having a diblock content of <1 wt %, a styrene content of about 30 wt %, and a melt flow rate (MFR) of about 13 dg/min.
“SBC2” is an SIS/SI copolymer blend having a diblock content of about 42 wt %, a styrene content of about 15 wt %, and an MFR of about 25 dg/min.
“SBC3” is a radial (SI)ₙ block copolymer having a diblock content of about 30 wt %, a styrene content of about 20 wt %, and an MFR of about 14 dg/min.
“PE” is a saturated ethylene-octene copolymer having a density of about 0.870 g/cm³ and an MFR of about 5 dg/min.
“PO” is a hydrotreated naphthenic process oil having a density of about 0.893 g/cm³ and a viscosity at 100° C. of about 9.0 cSt.
“EW” is a high melt index ethylene wax.

Adhesive blend compositions according to the invention having a variety of formulations were blended in an in-line continuous or continual process similar to that depicted in FIGS. 1 to 4. Those formulations (Examples 1-15) are reported below in Tables 1 and 2. Table 1 shows compositions of the blends based on the overall amounts of the first polymer component and the second polymer component, each of which comprises one or more additives. Table 2 details the weight percentages of the individual additives that are included in the amounts reported for the first and second polymer components in Table 1. All values in Tables 1 and 2 are reported as weight percent based on the total weight of the overall adhesive blend composition. Physical properties such as melting point, heat of fusion, and viscosity were determined for the adhesive blend formulations of Examples 1-15 and are reported below in Table 3.

TABLE 1

| Example No. | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| FPC1 | 20 | 27 | 27 | 37 | — | — | — | — | — | — | — | — | — | — | — |
| FPC2 | — | — | — | — | 20 | 25 | 15 | 35 | — | — | — | — | — | — | — |
| FPC3 | — | — | — | — | — | — | — | — | 15 | — | — | — | — | — | — |
| FPC4 | — | — | — | — | — | — | — | — | — | 20 | 25 | 34 | — | — | — |
| FPC5 | — | — | — | — | — | — | — | — | — | — | — | — | 20 | 27 | 36 |
| SPC1 | 80 | 73 | — | 63 | 80 | 75 | — | 65 | — | 80 | 75 | 66 | 80 | 73 | 64 |
| SPC2 | — | — | 73 | — | — | — | 85 | — | 85 | — | — | — | — | — | — |

TABLE 2

| Example No. | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| SPC1 | 79.4 | 69.6 | — | 60.1 | 79.4 | 71.5 | — | 61.9 | — | 79.6 | 71.5 | 62.9 | 80.0 | 69.6 | 62.0 |
| SPC2 | — | — | 69.6 | — | — | — | 81.0 | — | 81.0 | — | — | — | — | — | — |
| MaPP | — | 2.9 | 2.9 | 2.5 | — | 3.0 | 3.4 | 2.6 | 3.4 | — | 3.0 | 2.6 | — | 2.9 | 2.6 |
| AO | 0.7 | 0.6 | 0.6 | 0.6 | 0.7 | 0.6 | 0.7 | 0.7 | 0.7 | 0.7 | 0.6 | 0.7 | 0.7 | 0.6 | 0.6 |
| HCR1 | 11.0 | 14.8 | 14.8 | 20.3 | 11.7 | 14.6 | 8.7 | 20.4 | 9.2 | 3.9 | 4.9 | 6.8 | 5.5 | 7.9 | 10.0 |
| HCR2 | — | — | — | — | — | — | — | — | — | 3.9 | 5.0 | 6.8 | — | — | — |
| HCR3 | — | — | — | — | — | — | — | — | — | 4.0 | 5.0 | 6.8 | — | — | — |
| HCR4 | — | — | — | — | — | — | — | — | — | — | — | — | 5.6 | 7.9 | 10.0 |
| HCR5 | 1.9 | 2.6 | 2.6 | 3.5 | — | — | — | — | — | 1.0 | 1.3 | 1.7 | — | — | — |
| SBC1 | 4.0 | 5.4 | 5.4 | 7.4 | — | — | — | — | — | — | — | — | — | — | — |
| SBC2 | — | — | — | — | 3.6 | 4.5 | 2.7 | 6.3 | 3.0 | — | — | — | — | — | — |
| SBC3 | — | — | — | — | — | — | — | — | — | 5.0 | 6.3 | 8.5 | — | — | — |
| PE | — | — | — | — | — | — | — | — | — | — | — | — | 2.8 | 3.8 | 5.0 |
| PO | 3.0 | 4.1 | 4.1 | 5.6 | 4.6 | 5.8 | 3.5 | 8.1 | 2.7 | 1.9 | 2.4 | 3.2 | 4.6 | 6.2 | 8.3 |
| EW | — | — | — | — | — | — | — | — | — | — | — | — | 0.8 | 1.1 | 1.5 |

TABLE 3

| Example No. | 1 | 2 | 3 | 4 | 5 | 6 | 7 | 8 |
|---|---|---|---|---|---|---|---|---|
| Hf, 1^{st} melt (J/g) | 34.3 | 33.8 | 31.1 | 30.5 | 33.5 | 36.3 | 34.0 | 32.3 |
| Tm, 1^{st} melt peak 1 (° C.) | 47.5 | 47.4 | 47.5 | 46.7 | 47.3 | 48.5 | 47.5 | 47.5 |
| Tm, 1^{st} melt peak 2 (° C.) | 66.3 | 66.8 | 64.9 | 66.1 | 67.8 | 68.6 | 57.4 | 65.8 |
| Tm, 2^{nd} melt (° C.) | 67.5 | 69.2 | 69.8 | 69.7 | 68.3 | 69.6 | 70.7 | 69.3 |
| Hf, 2^{nd} melt (J/g) | 13.9 | 15.0 | 13.6 | 12.3 | 15.9 | 16.6 | 18.9 | 13.8 |
| Tc, 2^{nd} melt (° C.) | 28.8 | 24.0 | 27.8 | 26.5 | 25.6 | 21.4 | 18.4 | 26.4 |
| Tg (° C.) | −17.2 | −16.3 | −14.9 | −15.6 | −17.4 | −16.3 | −16.6 | −16.1 |
| Viscosity at 150° C. | 7550 | 7012 | 6887 | 5900 | 6937 | 5625 | 6525 | 5075 |
| Viscosity at 165° C. | 4835 | 4320 | 4235 | 3665 | 4270 | 3550 | 4155 | 3140 |
| Pellet viscosity at 177° C. | 3545 | 3110 | 3055 | 2655 | 3085 | 2615 | 3045 | 2235 |
| Pellet viscosity at 190° C. | 2665 | 2262 | 2210 | 1945 | 2232 | 1895 | 2230 | 1640 |
| Shore A hardness | 82/73 | 79/72 | 84/73 | 76/69 | 80/71 | 80/70 | 85/75 | 81/66 |
| (initial/5 sec) | | | | | | | | |
| Shore C hardness | 49/34 | 47/36 | 50/35 | 46/28 | 45/31 | 44/30 | 53/40 | 41/26 |
| (initial/5 sec) | | | | | | | | |
| Softening point (° C.) | 84.0 | — | — | — | — | — | 90.2 | — |

| Example No. | 9 | 10 | 11 | 12 | 13 | 14 | 15 |
|---|---|---|---|---|---|---|---|
| Hf, 1^{st} melt (J/g) | 37.5 | 35.2 | 55.1 | 36.6 | 25.7 | 32.8 | 23.4 |
| Tm, 1^{st} melt peak 1 (° C.) | 55.1 | 48.1 | 46.0 | 49.4 | 46.9 | 47.0 | 47.1 |
| Tm, 1^{st} melt peak 2 (° C.) | 74.8 | 68.9 | 66.6 | 135.4 | 64.9 | 66.4 | 66.3 |
| Tm, 2^{nd} melt (° C.) | 72.5 | 69.6 | 68.9 | 135.2 | 68.2 | 69.2 | 70.3 |
| Hf, 2^{nd} melt (J/g) | 23.4 | 16.4 | 15.3 | 33.2 | 11.9 | 15.6 | 9.3 |
| Tc, 2^{nd} melt (° C.) | 14.2 | 17.9 | 22.1 | — | 31.8 | 23.8 | 30.6 |
| Tg (° C.) | −16.7 | −18.1 | −17.1 | −15.6 | −16.7 | −16.3 | −14.8 |
| Viscosity at 150° C. | | 8875 | 7700 | 3515 | 7850 | 5987 | 5750 |
| Viscosity at 165° C. | | 5537 | 4815 | 2465 | 4900 | 3800 | 3655 |
| Pellet viscosity at 177° C. | | 3890 | 3510 | 1732 | 3535 | 2820 | 2690 |
| Pellet viscosity at 190° C. | | 2910 | 2590 | 1255 | 2575 | 2415 | 2015 |
| Shore A hardness | 87/76 | 84/75 | 82/74 | — | 82/72 | 80/68 | 83/71 |
| (initial/5 sec) | | | | | | | |
| Shore C hardness | 53/40 | 57/35 | 46/32 | — | 47/32 | 45/32 | 50/32 |
| (initial/5 sec) | | | | | | | |
| Softening point (° C.) | — | — | — | — | 83.8 | — | — |

For purposes of convenience, various specific test procedures are identified above for determining certain properties. However, when a person of ordinary skill reads this patent and wishes to determine whether a composition or polymer has a particular property identified in a claim, then any published or well-recognized method or test procedure can be followed to determine that property, although the specifically identified procedure is preferred. Each claim should be construed to cover the results of any of such procedures, even to the extent different procedures can yield different results or measurements. Thus, a person of ordinary skill in the art is to expect experimental variations in measured properties that are reflected in the claims.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

We claim:

1. A process for forming an adhesive blend composition, comprising:
a. providing, in a first vessel, a first component of the blend, wherein the first component comprises one or more styrenic block copolymers and one or more hydrocarbon tackifier resins;
b. providing, in a second vessel, a second component of the blend, wherein the second component comprises a polyolefin polymer;
c. providing a substrate to which the blend composition is to be applied;
d. extracting the first and second components of the blend from their respective vessels and continuously or continually mixing the first and second components to form an adhesive blend composition; and
e. applying the adhesive blend composition to the substrate.

2. The process of claim 1, wherein the second component is substantially free of hydrocarbon tackifier resins.

3. The process of claim 1, wherein the polyolefin polymer has a propylene content of at least 50 wt %, a heat of fusion from about 2 to about 120 J/g, and a weight average molecular weight (Mw) from about 15,000 to about 250,000.

4. The process of claim 1, wherein the first component, the second component, or both of the first and second components of the blend additionally comprise one or more additives.

5. The process of claim 1, wherein the one or more styrenic block copolymers are selected from styrene-isoprene block copolymers, styrene-butadiene block copolymers and styrene-isoprene-butadiene block copolymers.

6. The process of claim 1, wherein the one or more styrenic block copolymers are selected from radial styrene-isoprene block copolymers and radial styrene-butadiene block copolymers.

7. The process of claim 1, wherein the one or more hydrocarbon tackifier resins have a ring-and-ball softening point of from about 50 to about 140° C.

8. The process of claim 1, wherein the second component comprises a polyolefin copolymer comprising a propylene content of at least 70 wt %, a comonomer content of from about 1 to about 30 wt %, a weight average molecular weight (Mw) of about 15,000 to about 100,000, and a heat of fusion of about 10 to about 100 J/g; and wherein the comonomer is ethylene and/or a C₄ to C₁₂ alpha-olefin.

9. The process of claim 1, further comprising providing, in one or more additional vessels, one or more additional components of the blend, which are extracted from their respective vessels and mixed together with the first and second components of the blend during the extracting step (d).

10. The process of claim 1, wherein the first and second components of the blend are mixed in a static mixer.

11. The process of claim 1, wherein the first and second components of the blend are mixed in a spiral mixer.

12. The process of claim 1, wherein the first component of the blend comprises two or more additives.

13. The process of claim 1, wherein the second component of the blend comprises two or more additives.

14. The process of claim 1, wherein the adhesive blend composition comprises three or more additives.

15. The process of claim 14, wherein the adhesive blend composition comprises four or more additives.

16. The process of claim 4, wherein the additives are selected from tackifiers, waxes, functionalized polymers such as acid modified polyolefins, and/or anhydride modified polyolefins, antioxidants, oils, compatabilizers, fillers, adjuvants, adhesion promoters, plasticizers, low molecular weight polymers, block, antiblock, pigments, processing aids, UV stabilizers, neutralizers, lubricants, surfactants, nucleating agents, flexibilizers, rubbers, optical brighteners, colorants, diluents, viscosity modifiers, and oxidized polyolefins.

17. The process of claim 1, wherein the adhesive blend composition comprises from about 5 to about 45 wt % of the first component.

18. The process of claim 17, wherein the adhesive blend composition comprises from about 10 to about 40 wt % of the first component.

19. The process of claim 4, wherein the additives comprise from about 0.1 to about 40 wt % of the adhesive blend composition.

20. The process of claim 19, wherein the additives comprise from about 5 to about 25 wt % of the adhesive blend composition.

21. An adhesive blend composition prepared according to claim 1.

22. A substrate at least partially coated with an adhesive blend composition prepared according to claim 1.

23. The process of claim 1 further comprising:
(a) providing, in a third vessel, a third component of the blend, wherein the third component comprises one or more styrenic block copolymers;
(b) continuously or continually extracting the first and second and third components of the blend from their respective vessels and mixing the first and second and third components to form an adhesive blend composition before the composition is applied to the substrate.

24. The process of claim 1 wherein the first and second component are mixed and applied using a bi-alternating method comprising:
a) forming a first intermittent component predominantly comprising the first component;
b) applying the first intermittent component to a first substrate area;
c) forming a second intermittent component predominantly comprising the second component; and
d) applying the second intermittent component to a second substrate area.

25. The process of claim 24 wherein the substrate is a diaper and the first substrate area comprises at least one elastic member zone and the second substrate area comprises at least one non-elastic member zone.
